(19) United States
(12) Patent Application Publication
(10) Pub. No.: US 2019/0010682 A1
(43) Pub. Date: Jan. 10, 2019

(54) Systems, Devices, and/or Methods for Managing Showers

(71) Applicant: Scott Wright, Severn, MD (US)

(72) Inventor: Scott Wright, Severn, MD (US)

(21) Appl. No.: 15/643,469

(22) Filed: Jul. 6, 2017

(51) Int. Cl. E03C 1/02; A47K 3/28; E03C 1/05; F03B 13/10; F03B 3/00

(52) U.S. Cl. CPC E03C 1/021; A47K 3/281; A47K 3/283; E03C 2001/026; F03B 13/10; F03B 3/00; E03C 1/055

(57) ABSTRACT

Certain exemplary embodiments can provide a system that comprises a valve coupled to a water supply to a showerhead. The valve is constructed to turn a water flow on and off to the showerhead. The system comprises a first switch mounted outside of a shower stall. The first switch can be constructed to, responsive to a first user action, cause the valve to turn the water flow on.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 1000;

FIG. 2A is a block diagram of an exemplary embodiment of a system 2000;

FIG. 2B is a block diagram of an exemplary embodiment of a system 2500;

FIG. 3 is a block diagram of an exemplary embodiment of a system 3000;

FIG. 4 is a flowchart of an exemplary embodiment of a method 4000; and

FIG. 5 is a block diagram of an exemplary embodiment of an information device 5000.

### DETAILED DESCRIPTION

Certain exemplary embodiments can provide a system that comprises a valve coupled to a water supply to a showerhead. The valve is constructed to turn a water flow on and off to the showerhead. The system comprises a first switch mounted outside of a shower stall. The first switch can be constructed to, responsive to a first user action, cause the valve to turn the water flow on.

Certain exemplary embodiments can provide a hydroelectric powered, self-charging, wireless remote controlled, electric on-off water valve for a shower. Certain exemplary embodiments use a unique dual-switch, motion-sensing design, one switch for inside of the shower and another switch for outside of the shower. Both switches can turn your shower on or off with the touch of a button; however, the inside switch also uses the motion of your body to manage the water flow.

In certain exemplary embodiments, pressing a button in a bathroom or bedroom to start a shower and have water flowing to the shower to be hot and ready when a user enters. Certain exemplary embodiments stops water flow after water is warmed up if the user hasn't entered the shower, automatically restarting the water when the user enters the shower, thereby avoiding wasted water. Certain exemplary embodiments can, without ever using usual shower control fixtures, turn the water to the shower off and on with the light touch of a button during the shower to soap-up; scrub; shave; shampoo; and/or answer a call, etc. Certain exemplary embodiments can save water. For a typical 7 to 10 minute shower with a flowrate of approximately 2.5 gallon per minute can use approximately 10 to 15 gallons of water. With fresh water being in short supply for much of the world and many families struggling with limited hot water supplies, certain exemplary embodiments can save significant amounts of water and energy resources. Certain exemplary embodiments can assist institutions such as hotels, hospitals and/or other institutional facilities reduce water and energy use.

Certain exemplary embodiments comprise: a valve assembly; a first switch; and a second switch. The valve assembly can be a hydroelectric powered self-charging wireless remote controlled programmable automatic on-off electric ball type water valve unit mounted before the showerhead. The valve assembly can be any size, such as approximately 2.5 inches long. Certain exemplary embodiments use water system pressure as its energy source, costing little to operate. Materials of construction can comprise metal and/or plastic. The valve can comprise a lifetime lithium self-charging battery.

In certain exemplary embodiments, the first switch can measure approximately 2.5 inches in diameter and approximately ½ inch in depth wireless transmitter. The first switch can be mounted outside shower stall in a convenient location within approximately 20 feet of main valve unit. Materials of construction can comprise smooth finish plastic domed shape push button and/or a choice of colors. Certain exemplary embodiments can use a lithium battery, which can have an expected service life of over approximately 10 years. Installation can be facilitated via peel and stick adhesive or suction cups. A short press on a button turns valve on for initial water warm-up phase. Also turning a motion sensor of the second switch can determine if shower is occupied. Short press on the button again turns water off. A long press turns entire system off for vacation; etc.

In certain exemplary embodiments, the second switch measures approximately 5 inches in diameter and approximately ¾ inch in depth that includes a low power wireless transceiver (transmitter/receiver) can be mounted inside shower stall in a convenient location. Materials of construction can comprise a smooth finished plastic domed shape touch-sensitive push button and/or choice of colors. Certain exemplary embodiments can use a lithium battery, which can have an expected service life of over approximately 10 years. Installation can be facilitated via peel and stick adhesive or suction cups. A light button touch can turn water off or on and the built-in motion sensor sends motion data to valve assembly main unit to determine if shower is occupied. Motion initiates a shower-run phase. In certain exemplary embodiments, manually pressing and holding the button can deactivate the touch sensitive feature in order to set optional timer features and other settings. The button can be pressed and held again to reactivate. The second switch can also function as a manual push button.

Certain exemplary embodiments can provide: (a) hydroelectric powered self-charging design; (b) touch sensitive, dual, inside and outside of the shower wireless switches; (c) shower water pre-heating; (d) motion sensor activated automatic resume and shutoff; (e) user variable, shower run-time limiter; (f) voice activated control; (g) manual override control; and/or (h) a built-in L.E.D. lamp; etc.

Certain exemplary methods comprise one or more of:
Press the first switch, which causes the shower to automatically start a user adjustable timer causing an initial water warm-up phase.
If a shower door is opened or user enters within initial warm-up phase.
Water will continue to flow due to motion sensor presence-signals from the second switch being sent to the main valve processor, which starts a shower run phase.
If shower door is not opened or user does not enter within initial warm-up time, the valve will automatically stop water flow.
The valve will automatically resume flow when motion sensor in the second switch determines the shower door is opened and/or the user enters the showers.
An auto resume can be switched off if desired.
As the motion sensor in the second switch senses movement of user, it sends signals to a valve processor, thereby restarting the shower run phase, thereby keeping water flow continuous when user is present.
If the motion sensor does not detect the presence of the user, the shower valve will automatically shut down after a user adjustable period of time, thereby entering a standby mode.
The user can stop or start shower water flow as desired by touching the second switch; etc.

Certain exemplary embodiments can provide an initial warm-up phase. The user presses the first switch, which starts a user variable initial shower-on warm up timer event, which can last between approximately 10 seconds and approximately 2 minutes. The initial shower-on warm-up timer event should be set long enough for the shower water to fully warm-up. The water flow will stop after the timer ends, and waits for the user to enter the shower stall. If the user enters the shower before the timer ends, the flow will be continuous, due to signals being sent from the motion sensor in the second switch, which initiates the shower run phase.

Certain exemplary embodiments can provide a shower run phase. When the user enters shower, a motion sensor built into the second switch sends presence signals to the valve initiating a user variable shower-on run timer event, which can last between approximately 10 seconds and approximately 2 minutes. The water is turned on or remains on. Each time the valve controller receives user presence signals from the second switch motion sensor, the shower-on run timer event restarts, allowing water flow to be substantially continuous during showering. If no user presence signals are sent, water flow will stop after the user variable timer event runs out. Water flow can be stopped or started at any time by touching the second switch while showering.

Certain exemplary embodiments can be set up as follows:
An existing showerhead is removed and the valve is installed and the showerhead reinstalled.
The first switch is mounted in a convenient location outside shower stall such as within approximately 20 feet. The second switch is mounted to a wall of the shower in a location that is easy to touch while showering. Switches can be mounted with choice of suction cups or adhesive.
Shower water controls are set to “on” as is normally done when showering. Via the first switch and the second switch, water flow is turned on or off with water temperature being adjustable by the user.

In certain exemplary embodiments, a hydroelectric turbine can convert energy from water flowing to the showerhead to an output of approximately 27 watts, which can charge a built-in lithium rechargeable battery of the valve and/or provide energy to illuminate a built-in high output light emitting diode (“LED”) lamp for systems so equipped.

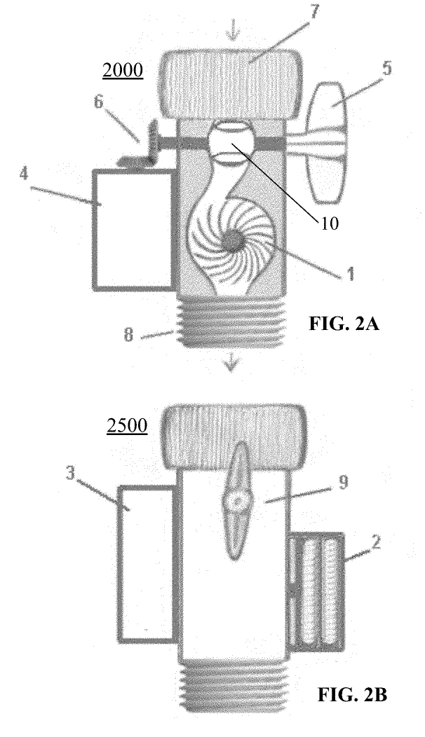

FIG. 2A is a block diagram of an exemplary embodiment of a system 2000.

FIG. 2B is a block diagram of an exemplary embodiment of a system 2500. A charging design can comprise:
an internal paddle wheel impeller 1 that is coupled to an external generator 2.
Internal impeller 1 drives external generator 2 via a sealed axle.
External generator 2 charges rechargeable lithium ion battery 3.
Motor and processor circuit board 4.
Manual control override 5.
Motor and ball valve drive gears 6.
Shower arm mount 8.
Showerhead Mount 9.
A valve 10 (e.g., a rotating type ball).

Because of the relative ease and touch-sensitive operation of exemplary systems, energy and water can be conserved when soaping-up; shaving; scrubbing and shampooing.

Certain exemplary embodiments can be considered “green” because energy from flowing water is used to power the controls, which controls also conserve water.

Certain exemplary embodiments can comprise one or more of the following options for the second switch: (a) a hair color timer can be built into switch; (b) a timer that allows the user to set the timer with: a 1 minute button adding single minute intervals and/or a 5 minute button for adding five minute intervals; (c) a start button; (d) a stop button; and/or (e) a reset button, etc.

Certain exemplary embodiments can comprise one or more options for the second switch, which can comprise a clock and water-usage timer that shows total shower time, total water usage time, and/or time of day, etc.

Certain exemplary embodiments can comprise a high output LED lamp to shower by, built into main valve assembly could save household electricity by not using the main bathroom light. Certain exemplary embodiments can comprise a manual override, which can allow the user to shower in the event of a malfunction.

The valve unit can have two rotating controls: one for a variable initial warm-up phase time (e.g., between approximately 10 seconds and approximately 2 minutes) and the other for shower run time (e.g., between approximately 10 seconds and approximately 2 minutes) after receiving motion sensor presence signals. The valve can have an on-off button.

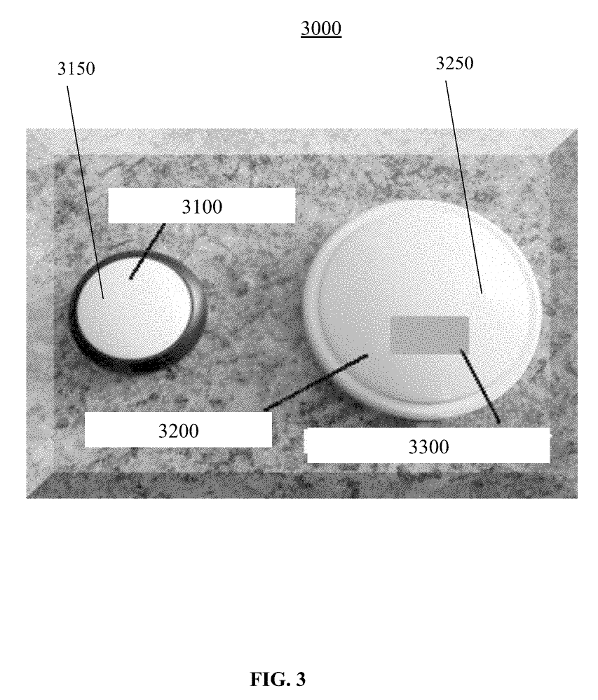

FIG. 3 is a block diagram of an exemplary embodiment of a system 3000. In certain exemplary embodiments, the first switch 3100 can be a push button switch and can have dimensions of approximately 2.5 inches in diameter and approximately ½ inch in depth. In certain exemplary embodiments, the second switch 3200 can be a touch sensitive switch and can have dimensions of approximately 5 inches in diameter and approximately ¾ inch in depth. The second switch can comprise a motion sensor 3300.

Certain exemplary embodiments turn shower water on or off remotely with just the touch of a button; have a self-charging integrated power supply, and can be automated. Certain exemplary embodiments provide one or more of: (a) a hydroelectric powered self-charging design; (b) a touch sensitive dual inside and outside of the shower wireless switches (buttons); (c) shower pre-heating; (d) motion sensor activated automatic resume and shutoff; (e) user variable shower run-time limiter; (f) optional voice activated control; (g) manual control; and/or (h) optional built-in lamp; etc.

Voice activated operation is possible with addition of a microphone added to the valve assembly. Voice activation can be useful for physically challenged users.

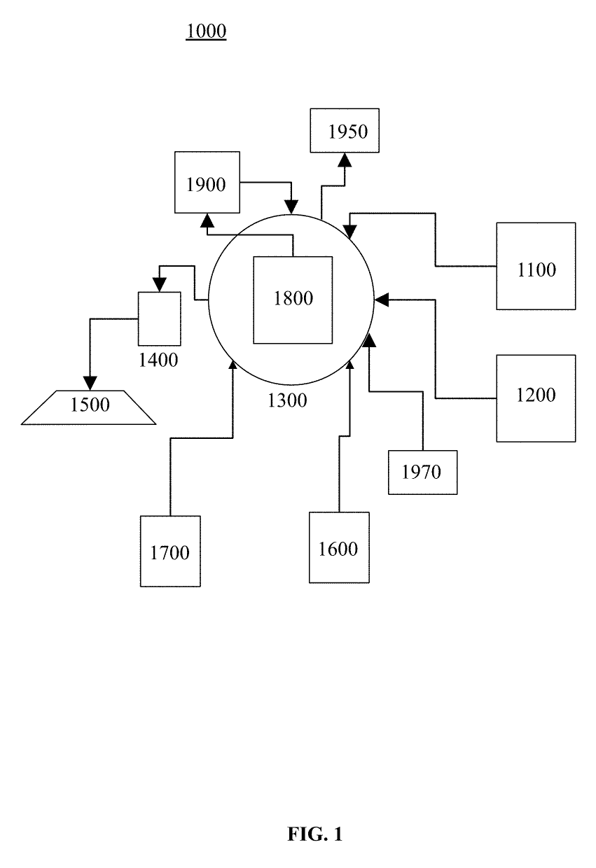

FIG. 1 is a block diagram of an exemplary embodiment of a system 1000, which comprises a valve 1300 that couples a water supply, hot water supply 1100 and/or cold water supply 1200, to a showerhead 1500. Valve 1300 is constructed to turn a water flow on and off to showerhead 1500.

Valve 1300 can be constructed to actuate responsive to a wireless signal. Valve 1300 can comprise a voice activated control 1970. Valve 1300 can be electrically coupled to battery 1900, which can be rechargeable. Valve 1300 can comprise a light emitting diode 1950 that provides illumination when valve 1300 is on. Valve 1300 can be constructed to:
adjust a first time period that valve 1300 is open responsive to a first signal from first switch 1600; and/or
adjust a second time period that valve 1300 is open responsive to a second signal from second switch 1700.

A hydroelectric turbine 1800 inside valve 1300 that provides electrical energy to charge a battery 1900 coupled to valve 1300 to provide electrical energy to actuate valve 1300 and perform other valve functions.

A first switch 1600 can be mounted outside of a shower stall. First switch 1600 can be constructed to:
responsive to a first user action, cause valve 1300 to turn the water flow on; and/or
turn the water flow off after a first predetermined time period.

First switch 1600 can comprises a user activatable push button that causes valve 1300 to turn water flow on and off. Responsive to pressing the user activatable button (see, e.g., button 3150 of FIG. 3) for a second predetermined time period, the first switch turns the system off.

A second switch 1700 can be mounted inside of the shower stall. Second switch 1700 can be coupled to a motion sensor (see, e.g., motion sensor 3300 of FIG. 3). The motion sensor (see, e.g., motion sensor 3300 of FIG. 3) causes valve 1300 to, responsive to detected movement of the user, automatically control the flow of water to showerhead 1500. Second switch 1700 can be constructed to:
determine a presence of a user; and
responsive to the determined presence of the user, automatically cause valve 1300 to turn the water flow on.

Second switch 1700 comprises a user activatable touch sensitive button (see, e.g., touch sensitive button 3250 of FIG. 3) that causes valve 1300 to turn water flow on and off. Responsive to pressing the user activatable button (see, e.g., touch sensitive button 3250 of FIG. 3) for a second predetermined time period, second switch 1700 turns the system off. Second switch 1700 can be constructed to cause valve 1300 to open for a second predetermined time period based on presence of the user. Second switch 1700 can be constructed to limit water run time to showerhead 1500 based upon the user not being present as determined by the motion sensor (see, e.g., motion sensor 3300 of FIG. 3). Second switch 1700 can be constructed to restart water flow to showerhead 1500 responsive to detected motion of the user. Second switch 1700 can comprise a timer that alerts the user of time elapsed. Second switch 1700 can comprise a clock and water-usage timer.

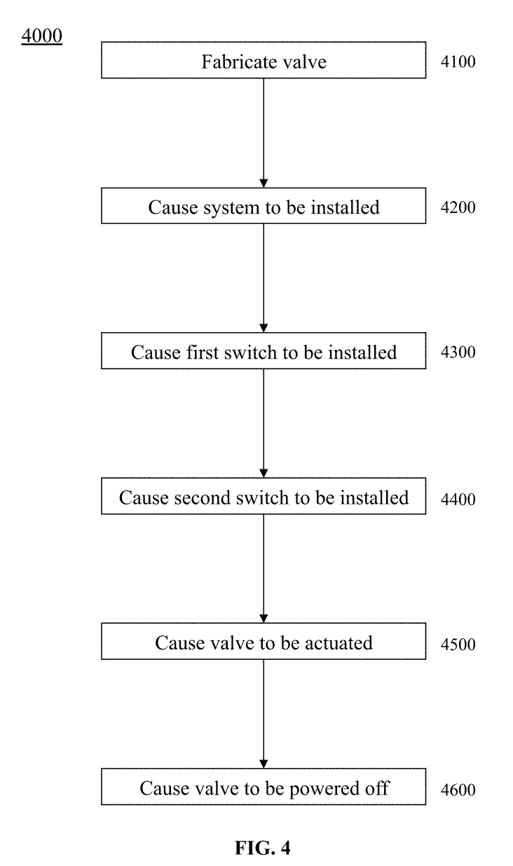

FIG. 4 is a flowchart of an exemplary embodiment of a method 4000. At activity 4100, a valve can be fabricated. At activity 4200, certain exemplary embodiments can comprise causing a system to be installed. The system can comprise:
the valve, which is coupled to a water supply to a showerhead, the valve is constructed to turn water flow on and off to the showerhead;
a first switch mounted outside shower stall, the first switch constructed to: (a) responsive to a first user action, cause the valve to turn the water supply on; and/or (b) responsive to a determination that a timed water on period sufficient to warm-up water and then shut valve off; and/or
a second switch mounted inside of shower stall, the second switch coupled to a motion sensor, the second switch constructed to: (a) detect a presence of a user; and/or (b) responsive to the detected presence of the user, automatically cause the valve to turn the water supply on.

Each of the first switch and the second switch can turn the valve on or off at any time responsive to a user action. At activity 4300, certain exemplary embodiments can comprise causing the first switch to be installed. At activity 4400, certain exemplary embodiments can comprise causing the second switch to be installed. At activity 4500, certain exemplary embodiments can comprise causing the valve to be actuated. At activity 4600, certain exemplary embodiments can comprise causing the valve to be powered off.

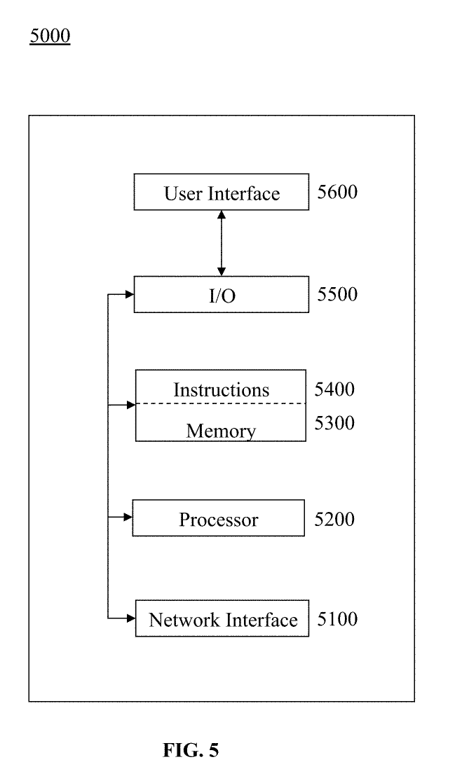

FIG. 5 is a block diagram of an exemplary embodiment of an information device 5000, which in certain operative embodiments can comprise, for example, first switch 1600 and/or second switch 1700 of FIG. 1. Information device 5000 can comprise any of numerous circuits and/or components, such as for example, one or more network interfaces 5100, one or more processors 5200, one or more memories 5300 containing instructions 5400, one or more input/output (I/O) devices 5500, and/or one or more user interfaces 5600 coupled to one or more I/O devices 5500, etc.

In certain exemplary embodiments, via one or more user interfaces 5600, such as a graphical user interface, a user can view a rendering of information related to any of the products, services, methods, and/or information described herein.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
action—something done.
activatable button—any small knob or disk pressed to cause an electric circuit to function or cease functioning.
activity—an action, act, step, and/or process or portion thereof
actuate—to put into mechanical motion.
adjust—to change to a sought state.
and/or—either in conjunction with or in alternative to.
apparatus—an appliance or device for a particular purpose
associate—to join, connect together, and/or relate.
automatically—acting or operating in a manner essentially independent of external influence or control. For example, an automatic light switch can turn on upon “seeing” a person in its view, without the person manually operating the light switch.
battery—one or more electrochemical cells adapted to convert stored chemical energy into electrical energy.
can—is capable of, in at least some embodiments.
cause—to produce an effect.
charge—to cause to store electrical energy such as in a battery.
circuit—an electrically conductive pathway and/or a communications connection established across two or more switching devices comprised by a network and between corresponding end systems connected to, but not comprised by the network.
clock—a device and/or system that measures and/or records time.
comprising—including but not limited to.
configure—to make suitable or fit for a specific use or situation.
constructed to—made to and/or designed to.
convert—to transform, adapt, and/or change.
couple—to join, connect, and/or link together.
create—to bring into being.
data—distinct pieces of information, usually formatted in a special or predetermined way and/or organized to express concepts.
data structure—an organization of a collection of data that allows the data to be manipulated effectively and/or a logical relationship among data elements that is designed to support specific data manipulation functions. A data structure can comprise metadata to describe the properties of the data structure. Examples of data structures can include: array, dictionary, graph, hash, heap, linked list, matrix, object, queue, ring, stack, tree, and/or vector.
define—to establish the outline, form, or structure of
determine—to obtain, calculate, decide, deduce, and/or ascertain.
device—a machine, manufacture, and/or collection thereof.
electrical—relating to producing, distributing, and/or operating by electricity.
electrical energy—energy characterized by the flow of electric charge through a conductor.
estimate—to calculate and/or determine approximately and/or tentatively.
exceed—to go beyond a limit.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
hydroelectric turbine—a rotary mechanical device that extracts energy from a fluid flow, via spinning from the fluid flow, and converts it into electrical energy.
illuminate—to cause to emit light.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
inside—within the confines of
light emitting diode—a two-lead semiconductor light source, which is a p-n junction diode that emits light when activated.
limit—to restrict something.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
motion sensor—a device that detects a moving person.
mount—to set or place.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
off—a state that substantially stops a liquid flow.
on—a state that substantially starts a liquid flow.
outside—external to the confines of.
packet—a discrete instance of communication.
plurality—the state of being plural and/or more than one.
predetermined—established in advance.
presence—a state of being in proximity to something.
press—to compress or squeeze.
probability—a quantitative representation of a likelihood of an occurrence.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
provide—to furnish, supply, give, and/or make available.
receive—to get as a signal, take, acquire, and/or obtain.
rechargeable—capable of being charged repeatedly.
recommend—to suggest, praise, commend, and/or endorse.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
responsive—reacting to an influence and/or impetus.
run time—a duration that water remains flowing to a showerhead.
select—to make a choice or selection from alternatives.
set—a related plurality.
showerhead—an overhead perforated nozzle in a bath in which water is sprayed on the body.
shower stall—a place, at least partially partitioned, in which a person bathes under a spray of water.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
store—to place, hold, and/or retain data, typically in a memory.
substantially—to a great extent or degree.
switch—a mechanical, electrical, and/or electronic device that opens and/or closes circuits, completes and/or breaks an electrical path, and/or selects paths and/or circuits.
system—a collection of mechanisms, devices, machines, articles of manufacture, processes, data, and/or instructions, the collection designed to perform one or more specific functions.
threshold—a point that when exceeded produces a given effect or result.
time period—a time interval.
timer—a device and/or system that measures an elapsed time.
transmit—to send as a signal, provide, furnish, and/or supply.
turn—to change a state of, as a valve being turned to change water flow.
user—any person, organization, process, device, program, protocol, and/or system that uses a device and/or service.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
valve—a device and/or system that is constructed to start, stop, and/or control the flow of water through a showerhead.
valve functions—actions that direct or control the flow of water by opening, closing, and/or partially obstructing water passageways.
via—by way of and/or utilizing.
voice activated control—a device and/or system that provides signals to a circuit via determination of a human voice command.
water flow—a moving stream of water.
water supply—a source of water to a showerhead.
water temperature—an indication of heat energy as measured by a thermometer and/or thermocouple, etc.
water usage—a quantity of water that flows during a predetermined time interval.
wireless—a transfer of information or power between two or more points that are not connected by an electrical conductor.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a valve that couples a water supply to a showerhead, the valve constructed to turn a water flow on and off to the showerhead;
a first switch mounted outside of a shower stall, the first switch constructed to:
responsive to a first user action, cause the valve to turn the water flow on; and
turn the water flow off after a first predetermined time period; and
a second switch mounted inside of the shower stall, the second switch coupled to a motion sensor, the second switch constructed to:
determine a presence of a user; and
responsive to the determined presence of the user, automatically cause the valve to turn the water flow on.

2. The system of claim 1, further comprising:
a hydroelectric turbine inside the valve that provides electrical energy to charge a battery coupled to the valve to provide electrical energy to actuate the valve and perform other valve functions.

3. The system of claim 1, wherein:
the valve is constructed to actuate responsive to a wireless signal.

4. The system of claim 1, wherein:
the valve is electrically coupled to a rechargeable battery.

5. The system of claim 1, wherein:
the first switch comprises a user activatable push button that causes the valve to turn water flow on and off.

6. The system of claim 1, wherein:
the first switch comprises a user activatable push button that causes the valve to turn water flow on and off; and
responsive to pressing the user activatable button for a second predetermined time period, the first switch turns the system off.

7. The system of claim 1, wherein:
the second switch comprises a user activatable touch sensitive button that causes the valve to turn water flow on and off.

8. The system of claim 1, wherein:
the second switch comprises a user activatable touch sensitive button that causes the valve to turn water flow on and off; and
responsive to pressing the user activatable button for a second predetermined time period, the second switch turns the system off.

9. The system of claim 1, wherein:
the motion sensor causes the valve to, responsive to detected movement of the user, automatically control the flow of water to the showerhead.

10. The system of claim 1, wherein:
the second switch is constructed to cause the valve to open for a second predetermined time period based on presence of the user.

11. The system of claim 1, wherein:
the second switch is constructed to limit water run time to the showerhead based upon the user not being present as determined by the motion sensor.

12. The system of claim 1, wherein:
the second switch is constructed to restart water flow to the showerhead responsive to detected motion of the user.

13. The system of claim 1, wherein:
the second switch comprises a timer that alerts the user of time elapsed.

14. The system of claim 1, wherein:
the second switch comprises a clock and water-usage timer.

15. The system of claim 1, wherein:
the valve comprises a light emitting diode that provides illumination when the valve is on.

16. The system of claim 1, wherein:
the valve is constructed to:
adjust a first time period that the valve is open responsive to a first signal from the first switch; and
adjust a second time period that the valve is open responsive to a second signal from the second switch.

17. The system of claim 1, wherein:
the valve comprises a voice activated control.

18. A method comprising:
causing a system to be installed, the system comprising
a valve coupled to a water supply to a showerhead, the valve constructed to turn water flow on and off to the showerhead;
a first switch mounted outside shower stall, the first switch constructed to:
responsive to a first user action, cause the valve to turn the water supply on; and
responsive to a determination that a timed water on period sufficient to warm-up water and then shut valve off; and
a second switch mounted inside of shower stall, the second switch coupled to a motion sensor, the second switch constructed to:
detect a presence of a user; and
responsive to the detected presence of the user,
automatically cause the valve to turn the water supply on.
wherein each of the first switch and the second switch can turn the valve on or off at any time responsive to a user action.
